(19) United States
(12) Patent Application Publication
(10) Pub. No.: US 2006/0178906 A1
(43) Pub. Date: Aug. 10, 2006

(54) Clinical development plan, facility development plan and process development plan knowledge bases

(76) Inventors: Christof Von Kalle, Cincinnati, OH (US); Lilith Reeves, Avon, IN (US); David Williams, Cincinnati, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 11/035,019

(22) Filed: Jan. 13, 2005

(51) Int. Cl. G06Q 99/00

(52) U.S. Cl. 705/2; 705/1

(57) ABSTRACT

Exemplary embodiments of the present invention provide three knowledge bases: (1) a clinical development plan (CDP) knowledge base for development of a molecular or cellular Phase I or II clinical trial; (2) a facility development plan (FDP) knowledge base for the economic and functional setup of translational laboratory, clean room production and cell handling facilities including the processes of planning, constructing and validating a facility for GCP testing and GMP manufacturing of products to support molecular and gene therapy clinical trials; and (3) a process development plan (PDP) knowledge base for development of manufacturing and analytic processes in support of Phase I or II clinical trials. The present invention also provides systems and methods associated with such knowledge bases.

### COPYRIGHTED MATERIAL

A portion of the disclosure of this patent document contains material which is subject to copyright protection. The copyright owner has no objection to the facsimile reproduction by anyone of the patent document or the patent disclosure, as it appears in the PTO patent files or records, but otherwise reserves all copyright rights whatsoever.

### BACKGROUND

The present invention relates to clinical development plans, facility development plans, and process development plans; and, more specifically, to systems, methods and apparatuses to facilitate consistent and efficient development of such plans.

Conventionally, there are two general models for guiding development of a product into clinical trials. In a first model, industry practice is to employ development teams to oversee the multiple aspects of a product from research through early and late phase trials and into licensure. This involves a substantial personnel and economic commitment and is generally not feasible in academic institutions preparing for trials to address typically very small populations, and have very limited opportunity for proceeding past Phase I or II.

In a second model, academic institutions may have groups knowledgeable in specific phases of trial development to support the academic PI/Sponsor. These may include a Data Management/Clinical Research Office (CRO) with expertise in clinical trial regulatory submissions and form development; a clinical laboratory with expertise in routine assays conducted within guidelines of Good Clinical Practices (GCP); cellular therapy laboratories with expertise in AABB approved cellular manipulation technologies; research laboratories with expertise in performing molecular manipulations in unique assays in research settings; and either a source for purchasing the active product for the trial or a research laboratory with expertise in making the product at a research grade. There is a distinct absence of a system to remind the investigator of all pre-requisites to a study or to coordinate the various resources within and outside the institution. In addition, there appears no systems in place that facilitates a learning and dissemination process for information related to documentation for submissions, and development of later trials.

With respect to facility development plans, academic institutions are dependent upon commercial contractors most phases of developing a new facility. The basic problem with this approach is that many outside contractors have sales forces but limited experience in a practical aspect of developing facilities for translational research in an academic setting. Their experience is most likely to have been in industry, which has markedly different needs in scale, flexibility of function, number of expected users, licensing, and funding.

Construction management in academic institutions is usually unfamiliar with specialized requirements for such facilities. Therefore, in the absence of on-site validation contractors, oversight of the construction process frequently fails to include appropriate safeguards as to suitable construction materials and retention of documents required for validations.

Even with the expense of hiring a validation contractor, end user input is frequently limited to faculty with an immediate plan (and the primary source of funding) for the facilities. However, it is rare that this person possesses the technical knowledge for directing development of a suitable facility. Approval to recruit and employ the person who will ultimately direct the operations of the facility is frequently delayed until near the end of the construction phase. Consideration of future shared use is typically only sought if assistance in finding is required.

The frequent result of the above is that the newly constructed facility often requires immediate retrofits, has compromised documentation of materials and construction changes for appropriate commissioning and validations. These shortcomings ultimately result in a marginal facility with significant delay in operational start-up.

With respect to process development plans (in support of Phase I and II clinical trials), the need for validation of manufacturing or analysis processes in academic institutions has only recently developed. As late as five years previous to the filing date of the present application, the regulatory bodies considered “academic General Manufacturing Practices (GMP)” and “sliding scale” compliance appropriate for academic clinical trials. However, not only were these standards not defined, the academic GMP concept itself was never actually documented. Therefore, as it is now accepted that all processes should be minimally validated. Prior to the present application, validation of processes in support of Phase I or II clinical trials generally consisted of either a research lab being able to provide the process at a “proof of concept” level or of purchasing validated services from industry at a higher cost. This application provides the guidance for investigators to meet the more rigorous standards.

### SUMMARY

Exemplary embodiments of the present invention provide three knowledge bases: (1) a clinical development plan (CDP) knowledge base for development of a molecular or cellular Phase I or II clinical trial; (2) a facility development plan (FDP) knowledge base for the economic and functional setup of translational laboratory, clean room production and cell handling facilities including the processes of planning, constructing and validating a facility for GCP testing and GMP manufacturing of products to support molecular and gene therapy clinical trials; and (3) a process development plan (PDP) knowledge base for development of manufacturing or analytical processes in support of Phase I or II clinical trials. The present invention also provides systems and methods associated with such knowledge bases.

Consequently, it is a first aspect of the present invention to provide a computer memory comprising a knowledge base for providing a CDP of a molecular or cellular Phase I or II clinical trial, where the knowledge base comprises itemized steps for the clinical development of a product from a research or development laboratory to a clinical trial. In a more detailed embodiment, the itemized plan provide steps for performing one, several, or all of the following tasks: (a) a task of establishing preclinical research, demonstrating proof of principal data and history of project development; (b) a task of developing the protocol and associated regulatory submissions and documents; (c) a task of establishing facility and equipment requirements; (d) a task of establishing manufacturing process requirements, including methods in raw material specifications for active and ancillary products; (f) a task of establishing data and specimen management documents and procedures; and (g) a task of establishing post-trial monitoring methods. Each of these tasks can include one or more subtasks. In yet a further detailed embodiment, the knowledge base comprises a spreadsheet, in which the tasks are itemized within the spreadsheet. In a further detailed embodiment, the spreadsheet includes links to external documents associated with one or more of the tasks. In a yet a further detailed embodiment the spreadsheet includes, for each task, a target date field, a note field and a date complete field. And yet a further detailed embodiment, the spreadsheet further includes for each task, a personnel assignment field.

It is a second aspect of the present invention to provide a computer memory that includes a knowledge base for providing a clinical facility development plan, where the knowledge base includes itemized steps for a clinical facility design, construction and validation. In a more detailed embodiment, the itemized steps provide steps for performing one, several or all of the following tasks: (a) a task of defining facility needs; (b) a task of developing clean room requirements; (c) a task of planning a regulatory pre-facilities meeting; (d) a task of planning design and construction; (e) a task of monitoring construction; (f) a task of validating master plan and facility; (g) a task of specifying, obtaining, and validating equipment; and (h) a task of preparing standard operating procedures. Each of these tasks can include one or more subtasks. In a further detailed embodiment, the knowledge base includes a spreadsheet, where the tasks are itemized within the spreadsheet. In a further detailed embodiment, the spreadsheet further includes links to external documents associated with one or more of the tasks. In yet a further detailed embodiment, the spreadsheet includes, for each task to be defined and subtasks, a target date field, a note field and date complete field. In yet a further detailed embodiment, the spreadsheet further includes, for each task, a personnel assignment field.

It is a third aspect of the present invention to provide a computer memory including a knowledge base for providing a process development plan for developing and validating manufacturing or analytic processes for a clinical trial in an academic or research institution, where the knowledge base includes itemized steps for the development and validation of the manufacturing or analytic process in an academic or research institution. In a detailed embodiment, itemized steps provide steps for performing one, several or all of the following tasks: (a) a task of defining a processes; (b) a task of reviewing facility suitability; (c) a task of defining applicable regulatory standards; (d) a task of defining process methodology; (e) a task of planning SOP development; (f) a task of specifying and acquiring support equipment; (g) a task of preparing final SOP and; (h) a task of implementing the process. Each of these tasks can include one or more subtasks. In a further detailed embodiment, the knowledge base includes a spreadsheet, where the tasks are itemized within the spreadsheet. In yet a further detailed embodiment, the spreadsheet includes links to external documents associated with one or more of the tasks. In yet a further detailed embodiment, the spreadsheet includes, for each task, a target date field, a notes field, and a date complete field. In yet a further detailed embodiment, the spreadsheet further includes for each task, a personnel assignment field.

With respect to each of the above knowledge bases, it is within the scope in the invention that the knowledge bases include a spreadsheet, where the tasks are itemized within the spreadsheet. It is also within the scope of the above inventions that the spreadsheets include means for indicating whether a specific task is complete. Furthermore, it is within the scope of the present invention that the spreadsheets are customizable by at least an administrator to meet specific requirements of a given project.

### BRIEF DESCRIPTION OF THE DRAWINGS

FIG. 1 is a schematic diagram of an exemplary representation of a computer system incorporating the memory device(s) storing the electronic knowledge bases and associated electronic documents according to the present invention;

FIG. 2 is a left-most segment of an exemplary knowledge base spreadsheet according to an exemplary embodiment of the invention;

FIG. 3 is a middle segment of the exemplary spreadsheet according to the present invention; and

FIG. 4. is a right-most segment of the exemplary spreadsheet according to the present invention.

### DETAILED DESCRIPTION

Exemplary embodiments of the present invention provide three knowledge bases: (1) a clinical development plan (CDP) knowledge base for development of a molecular or cellular Phase I or II clinical trial; (2) a facility development plan (FDP) knowledge base for the economic and functional setup of translational laboratory, clean room production and cell handling facilities including the processes of planning, constructing and validating a facility for GCP testing and GMP manufacturing of products to support molecular and gene therapy clinical trials; and (3) a process development (PDP) knowledge base for development of processes in support of Phase I or II clinical trials. The present invention also provides systems and methods associated with such knowledge bases.

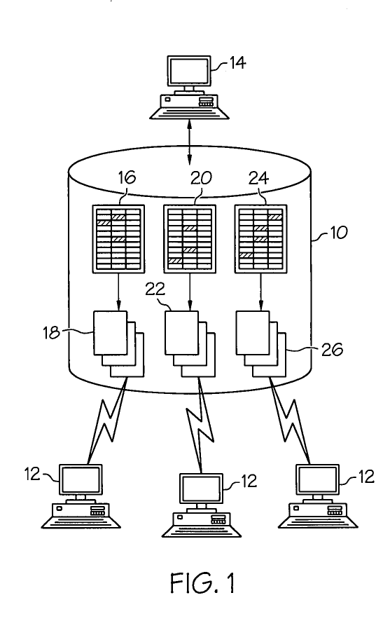

As shown in FIG. 1, an exemplary computer memory 10 according to the present invention is operatively coupled to a plurality of user computers 12 and an administrative computer 14. For the purpose of the present invention, “operatively coupled” pertains to any data link (analog, digital or otherwise) between the various components irrespective of whether any intermediate components may be interlinked there between. The memory device may be any computer memory accessible by one of the computers operatively coupled thereto; and in the exemplary embodiment, the memory device 10 may be, without limitation, a hard drive, an internal computer hard drive, a ROM device, a mobile memory device, a database, or a series or a combination of any of these. As will be described in further detail below, the memory device 10 includes one or more of the following: (a) a clinical development plan (CDP) spreadsheet knowledge base 16 and its associated documents 18; (b) a facility development plan (FDP) knowledge base spreadsheet 20 and its associated documents 22; and (c) a process development plan (PDP) knowledge base spreadsheet 24 and its associated documents 26.

Knowledge base spreadsheet 16, in an exemplary embodiment, is a clinical development plan (CDP) knowledge base spreadsheet that provides a worktable substitute for an in-house team or an expert in development of the clinical trial by itemizing the steps to be considered in moving a project from the research lab to the clinic. It provides a checklist format for insuring that the following major categories are addressed and completed in compliance with GCP and GMP and to the satisfaction of the principal investigator and the project team of experts from each of the specialized areas: (a) pre-clinical research demonstrating the “proof of principal” data and accurate history of project development; (b) protocol development and associated regulatory submissions and documents; (c) facility and equipment requirements; (d) manufacturing process requirements, including methods and raw material specifications for active and ancillary products; (d) data and specimen management documents and procedures; and (e) post-trial monitoring methods.

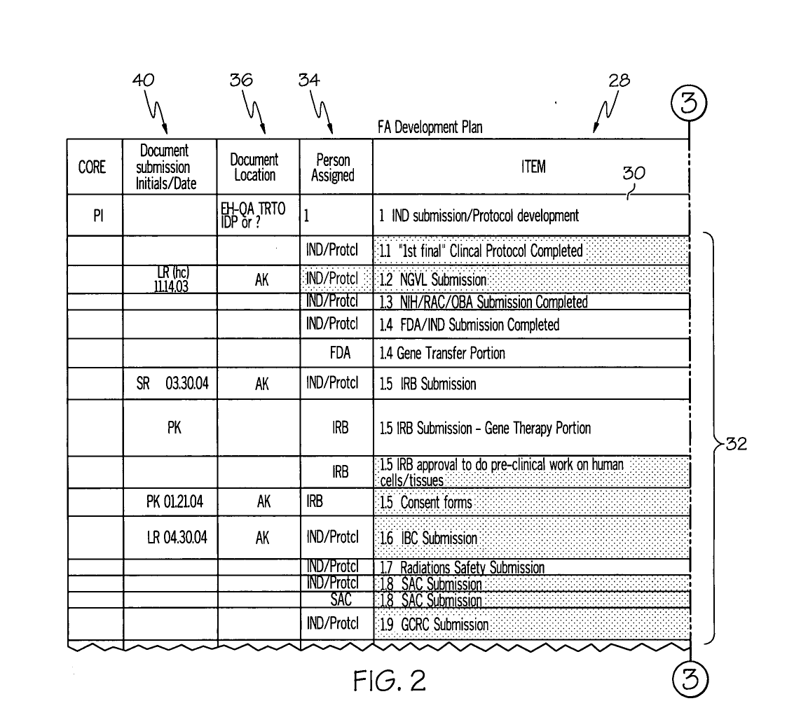

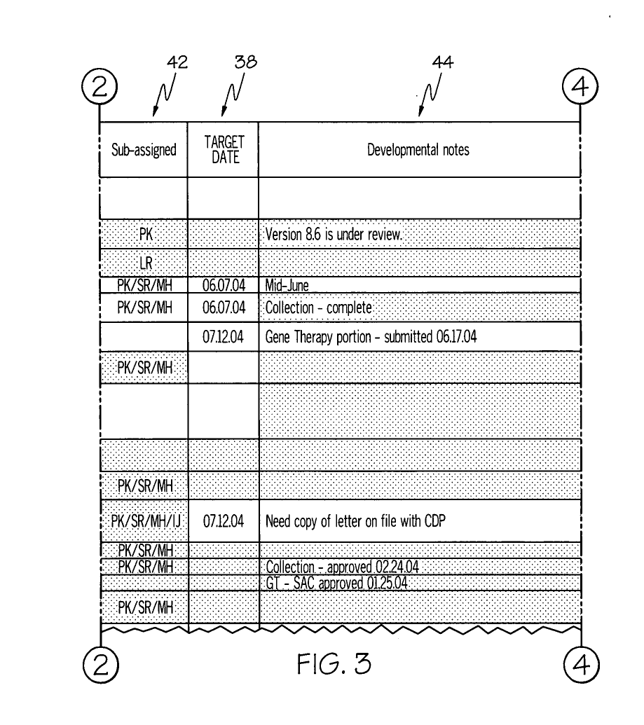

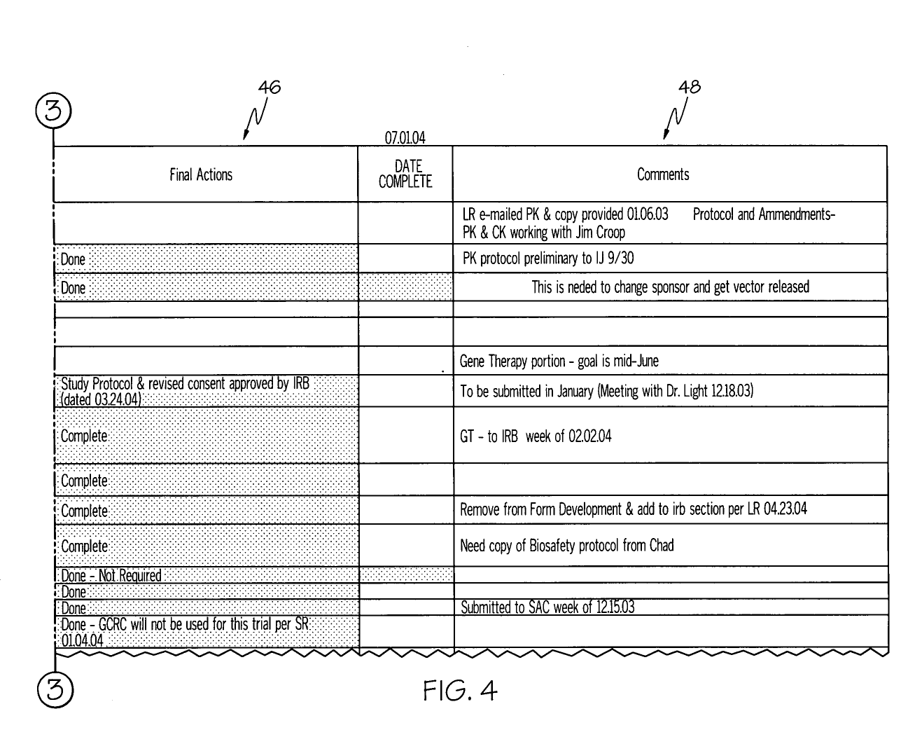

As shown in FIGS. 2-4, an exemplary section of a CDP knowledge base spreadsheet includes an “item” column 28, which provides the itemized tasks set forth in a hiarchy format. For example, the major task would be “IND submission/protocol development” 30, which includes a number of subtasks 32 set forth therebelow. As shown in this example, the exemplary spreadsheet allows an administrator (or others having authorized access) to shade tasks that have been completed. Certainly, those of ordinary skill will appreciate that there are other similar ways to indicate various itemized tasks have been completed such as providing other types of visible indicia (e.g., highlights, checkmarks, different colors, and the like).

The exemplary knowledge base spreadsheet also includes a “person assigned” column 34, which provides an indication of the people assigned to a specific task; a document location column 36, which provides information concerning the location of documents that need to be completed or that have been completed in accordance with completing a particular task; a target date column 38, which indicates a target date for completion of a task and/or a date that the task has actually been complete; a “document submission initial/date” column 40, which provides the initials of the person who submitted the particular document and the date that the document had been submitted; and a “sub-assigned” column 42, which provides the initials of individuals who are responsible for subtasks associated with the primary task given in the assignment, and typically report to the individuals in the “person assigned” 34 column. The document location column 36 may also provide hyperlinks or other types of data links (such as address look-ups) to such electronic format documents as will be appreciated by those of ordinary skill in the art. By including these data fields for each task, this spreadsheet allows the status of the project to be assessed by any of the various parameters, including date, task category, or participant.

A “developmental notes” column 44 provides a space for developmental notes; a “final actions” column 46 provides a field indicative of whether a final action has been completed or still needs to be completed; and the “comments” column(s) 48 allows for dynamic entrance of comments by the individuals working on the project as the project proceeds. In the exemplary embodiment, this “dynamic comments” column(s) 48 allows the most recent entries in the column to be listed therein while previous entries are archived within the knowledge base spreadsheet in archival columns that are moved to the right within the spreadsheet (keeping all comments on the same row but organizing them chronologically left-to-right, with the most recent comments on the right).

Specific benefits resulting from the use of this CDP knowledge base include, for example, single site access to all documents 18, communications and decisions related to a project. It facilitates real-time monitoring of the full scope of a project by the entire development team and is most useful for the sponsor and PI. Each document 18 is categorized by project, area of work and type, and is documented at a level suitable for regulatory submissions. The CDP knowledge base spreadsheet assures that all work is done in acceptable and efficient chronology and at a level of completeness suitable for regulatory submissions. The CDP knowledge base spreadsheet allows for better informed decisions regarding priorities and the resource utilization by allowing management to view a summary of all current work related to each product. The CDP knowledge base spreadsheet enables quicker ramp-up and thus speedup and reduces the cost of each overall project. It serves as a starting point for people assigned to a project in any point in its life cycle, allowing them to come up to speed on everything that has happened previously. It improves the quality of decisions and reduces lost time and effort by keeping primary investigators and other team members up-to-date regarding project status changes made by colleagues.

Table A of this application provides a standard form template of the exemplary embodiment of the CDP knowledge base spreadsheet 16. It is envisioned that this form template will be customized by the administrator and/or the development team at an early stage of the process as discussed below.

Generally, the process begins with the researcher or clinician identifying a research technique as having strong potential for translation to a Phase I or II clinical trial. The Molecular and Gene Therapy Program Leader and Translational Research Operations Director compare the research history and pre-clinical data to the CDP pre-clinical acceptance criteria. If the study is not suitable for acceptance into the CDP process and the reasons are made clear to the researcher, the process terminates at this point. If the study is suitable for acceptance into the CDP process, with or without additional specific pre-clinical work or documentation, the process continues as below.

The Principal Investigator, Molecular and Gene Therapy Program Leader and Translational Research Operations Director identify a Project Manager with a working knowledge of the proposed study, strong organization and communication skills and approximately 10-20% of his/her time available to be devoted to the project. The Project Manager uses the CDP knowledge base spreadsheet 16 as a guide to ask pertinent questions, issue timely reminders and oversee and prompt the actions of the basic researchers, clinicians, and others involved in the project development.

The PI, Molecular and Gene Therapy Program leader and Translational Research Operations Director identify a project team including representatives from the following: (a) the pre-clinical development/research team; (b) Regulatory Oversight; (c) Clinical Research Services; (d) laboratories providing manufacture of raw materials; (e) laboratories providing services for conducting the trial; (f) laboratory to provide post-trial monitoring; and (g) document support/archiving.

A schedule of meetings is prepared. Monthly meetings in general are appropriate. A definition of what is to expected of each team member in regard to meeting input is defined and communicated.

The Project Manager, the PI, the Molecular and Gene Therapy Program Leader and/or the Translational Research Operations Director and the Document Control person meet prior to the first overall meeting to prepare the customized CDP knowledge base spreadsheet 16. The CDP 16 is customized to meet the specific design of the project and major task categories are reviewed point by point and CDP team member preliminary assignments are made. The entire team meets thereafter to complete assignment of sub-task and expected completion dates for initial requisites.

Approximately one week in advance of each project team meeting, the Project Manager and Document Control person will review and update the status of each point/task. All tasks are reviewed and progress is noted. Previous entry information is moved to the right column for archive history. Completed items (including archive of full documentation) are shaded to indicate completion of that item.

Between meetings the Project Manager communicates with team members to facilitate development when documentation is needed. At each CDP meeting the team members present their progress and discuss potential problems or modifications to the previous plan. All progress is hardcopy documented at a quality suitable for regulatory submissions. The Document Control person notes completion upon receiving and filing the documentation 18.

As the process nears completion the PI and Project Manager review the entire CDP 16 to assure that all items are fulfilled and documented. Once completed the entire project is archived. Thereafter the process and all accompanying development history are available for review if issues develop in the conduct of the trial. The history of the development is available to be adopted into similar projects as well.

A second knowledge base spreadsheet 20 according to an exemplary embodiment provides a facility development plan (FDP) for the economic and functional setup of translational laboratory, clean room production and cell handling facilities including the process of planning, constructing and validating a facility for GCP testing and GMP manufacturing of products to support molecular and gene therapy clinical trials.

As with the CDP knowledge base spreadsheet 16, the FDP knowledge base spreadsheet 20 is a sophisticated spreadsheet that provides guidance for an in-house development team to effectively manage (a) design, (b) construction oversight, and (c) facility validation. The FDP knowledge base spreadsheet provides existing institutional personnel a detailed and comprehensive checklist for assuring that the appropriate phases of construction are addressed and completed in compliance with GCP and GMP and to the satisfaction of a product team of experts from each of the following specialized areas: (a) construction management services; (b) institutional central facilities systems management; (c) end user technical personnel (GCP and GMP knowledgeable); (d) and user validation and quality assurance personnel; (e) clinical trial PI's and/or sponsors; and (f) institutional safety and regulatory compliance personnel. It provides a checklist format for insuring that the following major categories are addressed and completed in compliance with GCP and GMP and to the satisfaction of the principal investigator and the project team of experts from each of the specialized areas: (a) defining facility needs; (b) developing clean room requirements; (c) planning a regulatory pre-facilities meeting; (d) planning design and construction; (e) monitoring construction; (f) validating master plan and facility; (g) specifying, obtaining, and validating equipment; and (h) preparing standard operating procedures.

The FDP knowledge base spreadsheet 20 allows everybody in the developmental team to check the status of the full scope of a given project for accessing a single source. It serves as a single repository—a single point of reference for all team members on management—for all documents 22, communications and decisions related to a given project. Each document 22 is categorized by project, area of work and type, and is documented at a level suitable for regulatory submissions. The FDP knowledge base spreadsheet assures that all work is done in an appropriate chronology and at an acceptable level of compliance for regulatory submissions. It allows for better informed decisions regarding priorities and resource utilization by allowing management to view a summary of the current work related to each project.

The FDP knowledge base spreadsheet enables quicker ramp-up and that speeds up and reduces the cost of each overall project. It serves as a starting point for people assigned to a project at any point in its life cycle, allowing them to come up to speed on everything that has happened previously. It helps organize work by serving as a to-do list for the team members working on each project. The tool, and therefore, the process will improve for each subsequent project as a result of adequate historical documentation and ready document retrieval. They will also improve the quality of decisions and reduce lost time and effort by keeping primary investigators and other team members up-to-date regarding project status changes made by colleagues.

Table B of this application provides a standard form template of the exemplary embodiment of the FDP knowledge base spreadsheet 20. It is envisioned that this form template will be customized by the administrator and/or the development team at an early stage of the process as discussed below.

In an exemplary process, a facility is first identified to be required. The key institutional construction management, design, and end user personnel then evaluate the scope of the project and institutional resources to determine if the facilities development plan will (FDP) provide adequate guidance for management of the project and if adequate institutional resources are available to implement the FDP. If the project is not suitable for acceptance into the FDP process and the reasons are clearly documented, the project is ended at this point. Otherwise, if it is determined that the process is suitable for acceptance into the FDP process, the process will continue as set forth below.

The key institutional construction management, design, and end user personnel identify a project manager with the following desired characteristics: (a) a working knowledge of the proposed facility; (b) strong organization and communication skills; and (c) having approximately 10-20% of his or her time available to be devoted to the project.

The project manager uses the FDP knowledge base spreadsheet 20 as a guide to ask pertinent questions, issue timely reminders and oversee and prompt the actions of the facilities personnel, researchers, regulatory, safety and compliance personnel and other involved in the project development.

The key institutional construction management, design, and end user personnel identify a project team including representatives from the following (as applicable): (a) construction management; (b) central facilities systems management; (c) end user technical personnel (GCP and GM knowledgeable); (d) end user validation and quality assurance personnel; (e) clinical research services (i.e., clinical trials, clinical trial PIs and/or sponsors); (f) institutional safety personnel; (g) regulatory oversight personnel; (h) laboratories providing manufacturer of related raw materials; (i) laboratories providing service for conducting the trial; (j) laboratories to provide post-trial monitoring; and (k) document support/archiving.

A schedule of meetings is then prepared. Bi-monthly meetings in general are typically appropriate and a definition of what is expected of each team member in regard to meeting input is defined and communicated. The Project Manager, the key institutional personnel, and the Document Control person meet prior to the first overall meeting to prepare and customize the FDP knowledge base spreadsheet 20, to meet the specific design of the project. Major task categories are reviewed point-by-point and FDP member preliminary assignments are made. The entire team then meets to complete assignment of sub-task and expected completion dates for initial requisites.

Approximately 3 to 5 days in advance of each project team meeting, the Project Manager and Document Control person review and update the status of each point. All tasks are reviewed and progress is noted. Previous entry information is moved to the next right column for archive history. Completed items (including archive of full documentation) are shaded to indicate completion of that item. Between meetings, the Project Manager communicates with team members to facilitate development and documentation as needed. At each FDP meeting, the team members present their progress and discuss potential problems or modifications to the previous plan. All progress is hard copy documented at a quality suitable for regulatory submissions. The Document Control person notes completion upon receiving and filing documentation 22.

As this process nears completion, the key institutional personnel and Project Manager review the entire FDP knowledge base spreadsheet 20 to assure that all items are fulfilled and documented. Once completed, the entire process is archived. The process and all accompanying development history is thereafter available for review if issues develop in the operations of the facility. The history of the development is available to be adopted into similar projects.

A third exemplary knowledge base spreadsheet 24 is a process development plan (PDP) knowledge base spreadsheet. The PDP knowledge base spreadsheet 24 provides a single person or an existing dedicated team with a knowledge base for SOP development, process and equipment validations, appropriate raw material specifications, manufacturing production or assay records, and current sophisticated research techniques in the academic environment. The PDP knowledge base spreadsheet 24 provides an effective tool for tapping the existing expertise to effectively develop a validated translational research process using an institution's existing personnel. It provides a checklist format for insuring that the following major categories are addressed and completed in compliance with GCP and GMP and to the satisfaction of the principal investigator and the project team of experts from each of the specialized areas: (a) defining a processes; (b) reviewing facility suitability; (c) defining applicable regulatory standards; (d) defining process methodology; (e) planning SOP development; (f) specifying and acquiring support equipment; (g) preparing final SOP and validation documents and; (h) implementing the process.

The FDP knowledge base spreadsheet 24 allows everyone on the development team to check the status of the full scope of a given project by accessing a single source. It serves as a single repository—a single point of reference for all team members in management—for all documents 26, communications and decisions related to a given project. Each document 26 is categorized by project, area of work and type, and is required to be documented at a level suitable for regulatory submissions. The FDP knowledge base spreadsheet 24 assures that all work is done in appropriate chronology and at the acceptable level of compliance for regulatory submissions. It allows for better informed decisions regarding priorities and resource utilization by allowing management to view a summary of the current work related to each project.

The PDP knowledge base spreadsheet 24 enables quicker ramp-up and thus speeds up and reduces the cost for each overall project. It serves as a starting point for people assigned to a project at any point in its life cycle, allowing them to come up to speed on everything that has happened previously. It helps organize work by serving as a to-do list for the team members working on each project. The PDP knowledge base spreadsheet 24 and, therefore the process, will improve for each subsequent project as a result of adequate historical documentation and ready document retrieval. It improves the quality of decisions and reduces lost time and effort by keeping primary investigators and other team members up to date regarding project status changes made by colleagues.

Table C of this application provides a standard form template of the exemplary embodiment of the PDP knowledge base spreadsheet 24. It is envisioned that this form template will be customized by the administrator and/or the development team at an early stage of the process as discussed below.

In an exemplary process, a process to be validated is first identified. Key research and validation personnel evaluate the scope of the process and related preliminary work, as well as the institutional resources, to determine if the process is adequately developed to be validated and if the institutional resources are available to support the process development plan. If the project is not suitable for acceptance into the PDP process, the reasons for such decision is documented and the project is not entered into the PDP knowledge base spreadsheet 24. However, if the project is suitable for acceptance into the PDP process, the process will continue as below.

The Project Manager is identified by the key research and validation personnel. Preferably, the Project Manager will have a working knowledge of the proposed process, strong organization and communication skills, and ten to fifteen percent of his/her time available to be devoted to the project. A project team is then defined to include representatives from the following: research personnel with the technical skills required; other laboratory personnel with expertise in SOPs and validations; regulatory representatives; representatives of end users for the validated process; and Document Support/archiving personnel.

The Project Manager uses the PDP knowledge base spreadsheet 24 as a guide to ask pertinent questions, issue timely reminders and oversee prompt actions of the basis researchers, regulatory representatives, and others involved in the project development.

A schedule of meetings is prepared. Bi-monthly meetings in general are appropriate. A definition of what is expected of each team member in regard to the meeting input is defined and communicated. The Project Manager, the key validation and research personnel, and the Document Control person meet prior to the first overall meeting to prepare or customize PDP knowledge base spreadsheet 24 from the standardized form to meet the specific design of the particular project. Major task categories are reviewed point by point and PDP team member preliminary assignments are made.

The entire team then meets to complete assignment of sub-tasks expected completion dates for initial requisites. Approximately three to five days in advance of each project team meeting, the Project Manager and Document Control person review and update the status of each point. All tasks are reviewed and progress is noted. Previous entry information is moved to the next right column for archive history. Completed items (including archive of full documentation) are shaded to indicate completion of that item.

Between meetings, the Project Manager communicates with the team members to facilitate development and documentation is needed. At each PDP meeting, the team members present their progress and discuss potential problems or modifications to the previous plan. All progress is hard copy documented at a quality suitable for regulatory submissions. The Document Control person notes completion upon receiving and filing such documentation.

As the above process nears completion, the key end user and Product Manager review the entire PDP knowledge base spreadsheet 24 to ensure that all items are fulfilled and documented. Once completed, the entire project is archived. The process and all accompanying development history is available for review if issues develop in the operations of the facility. The history of the development is available to be adopted into similar projects.

TABLE A

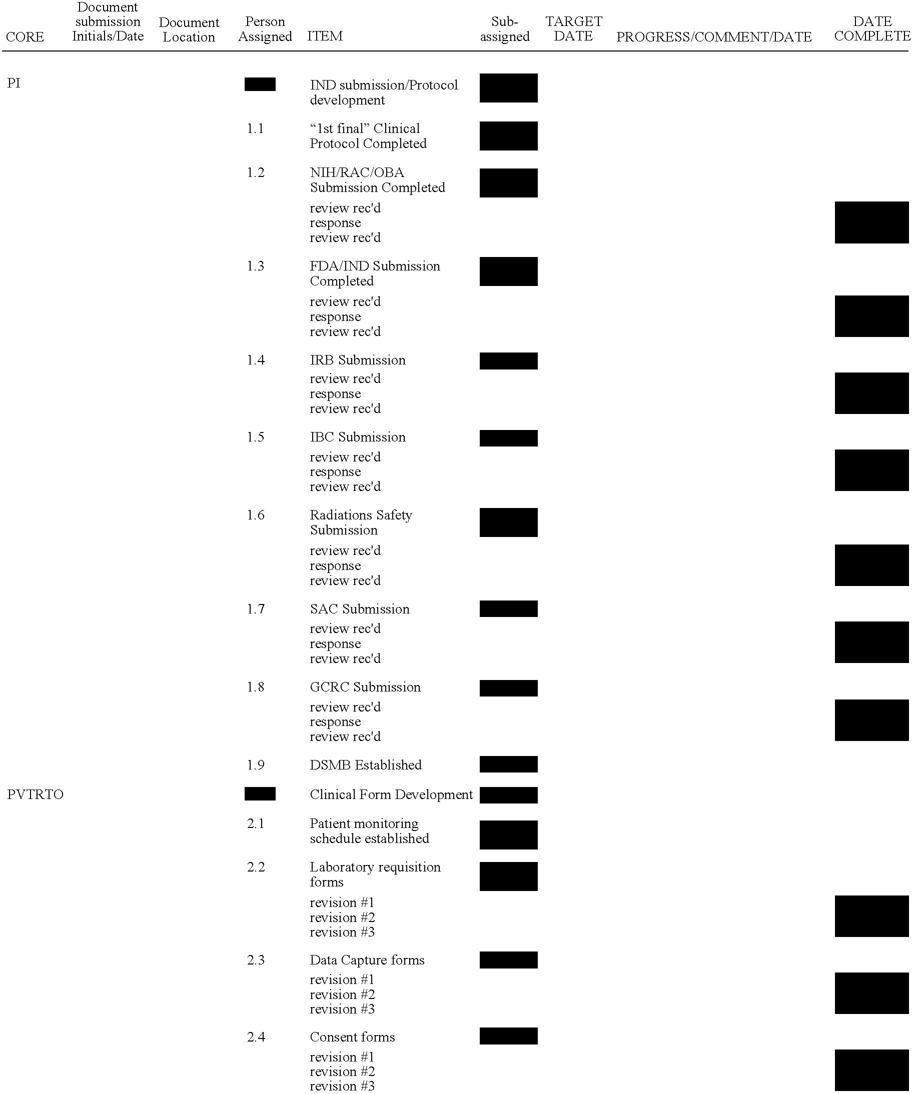

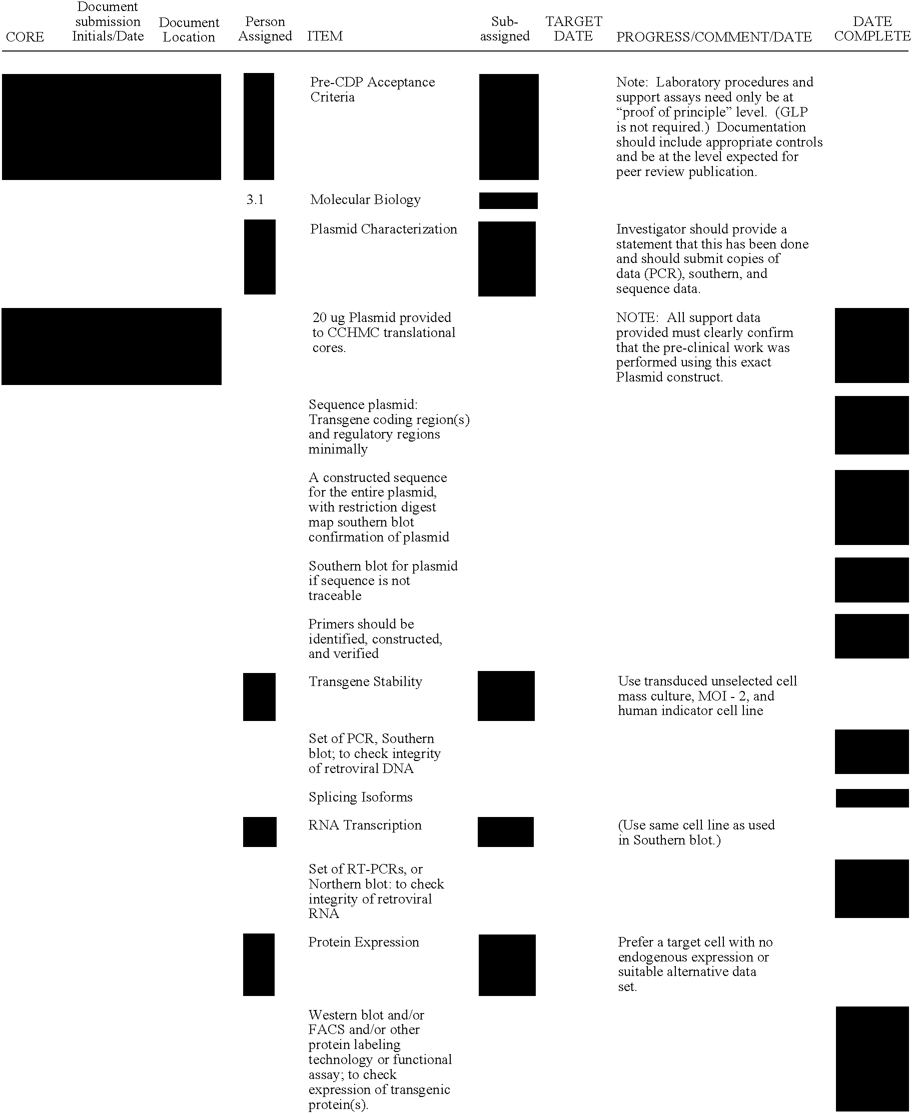

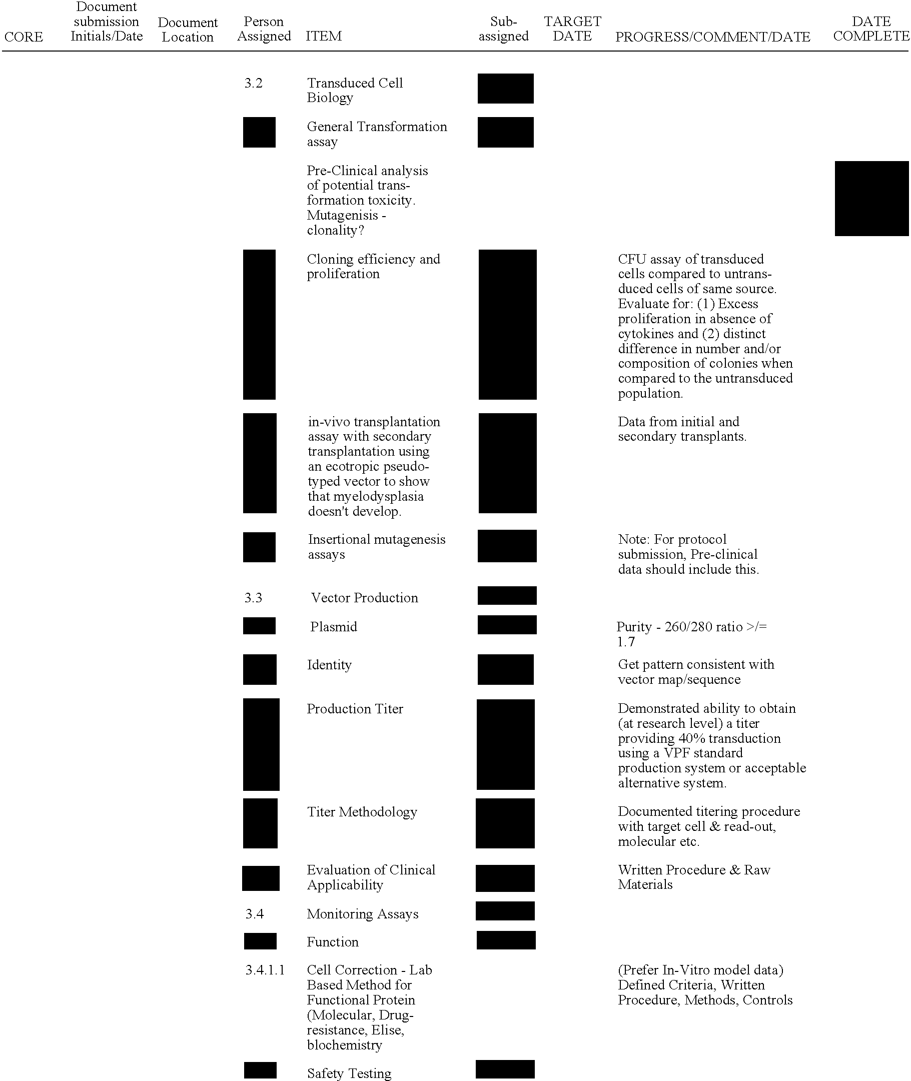

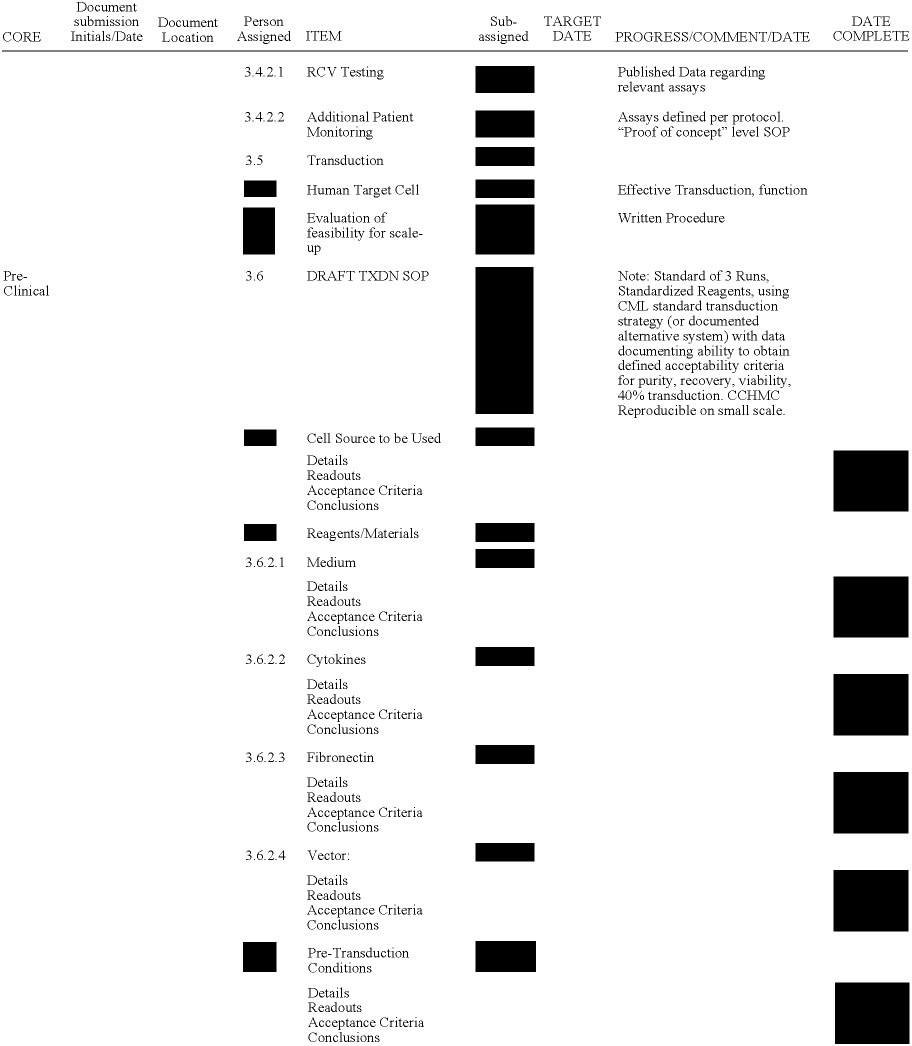

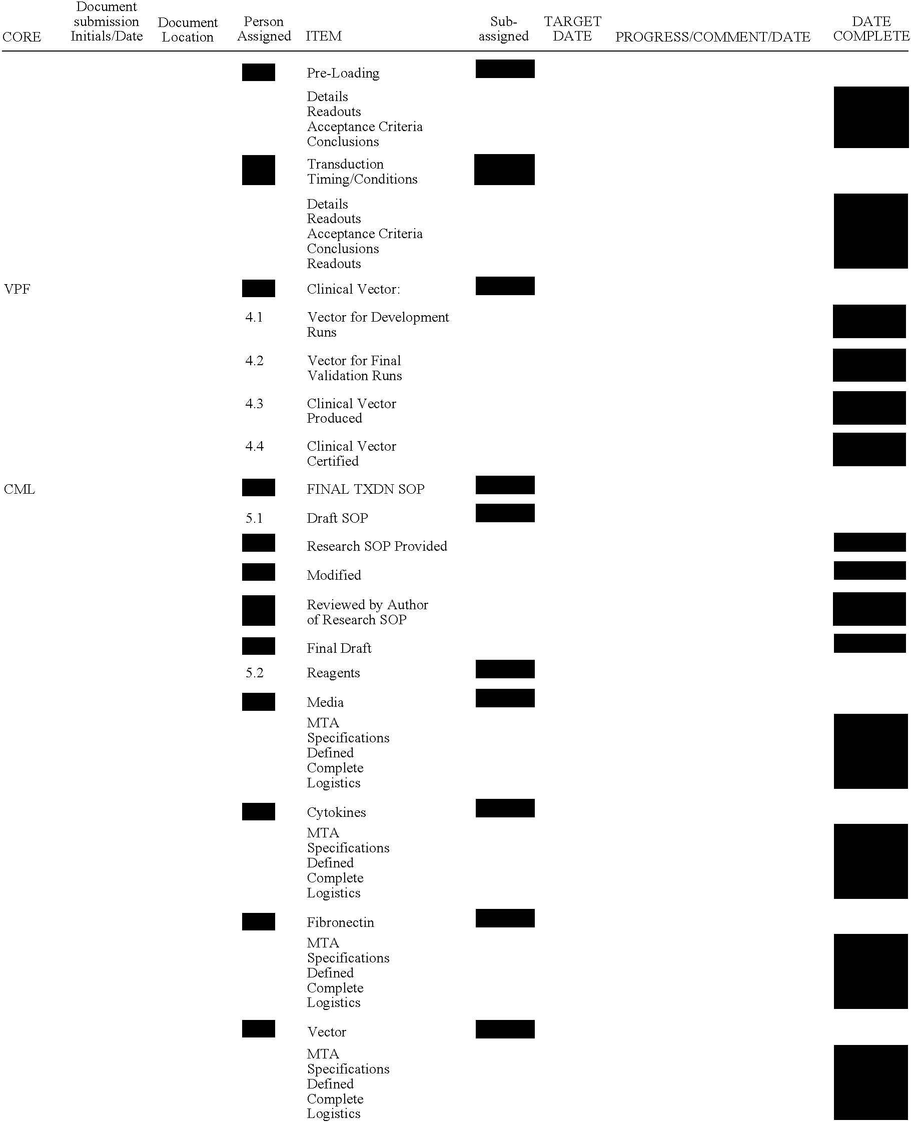

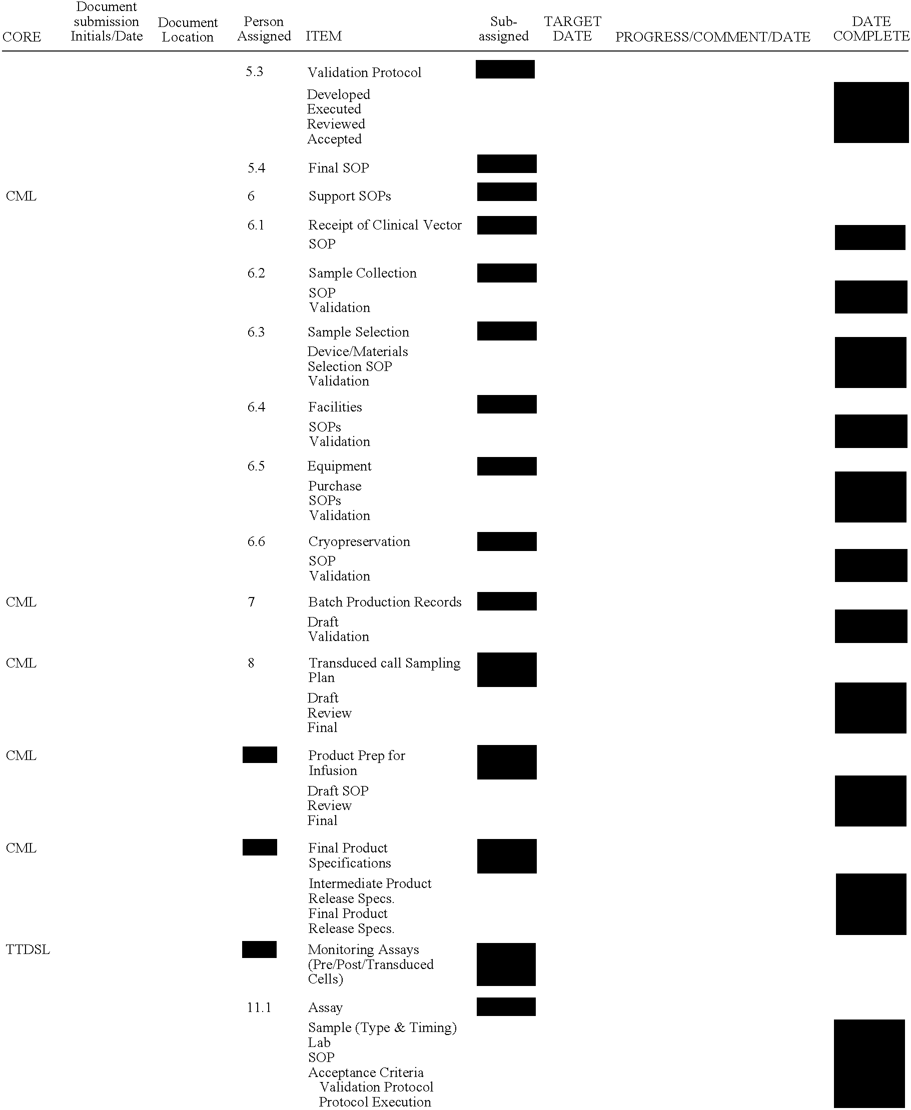

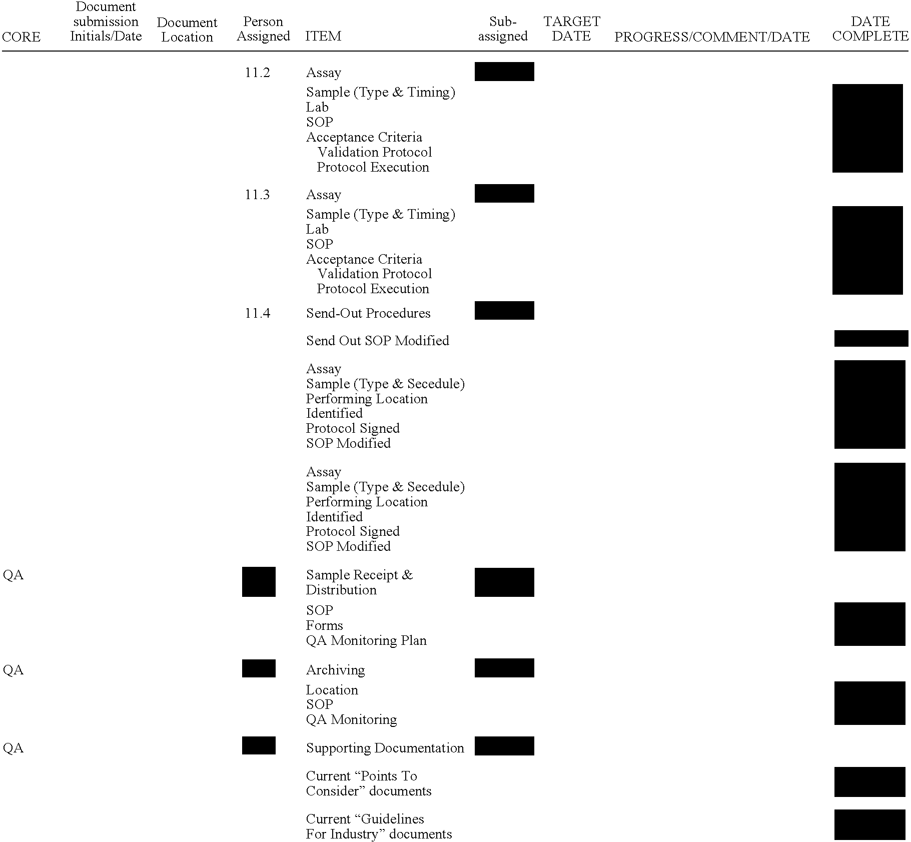

TABLE B

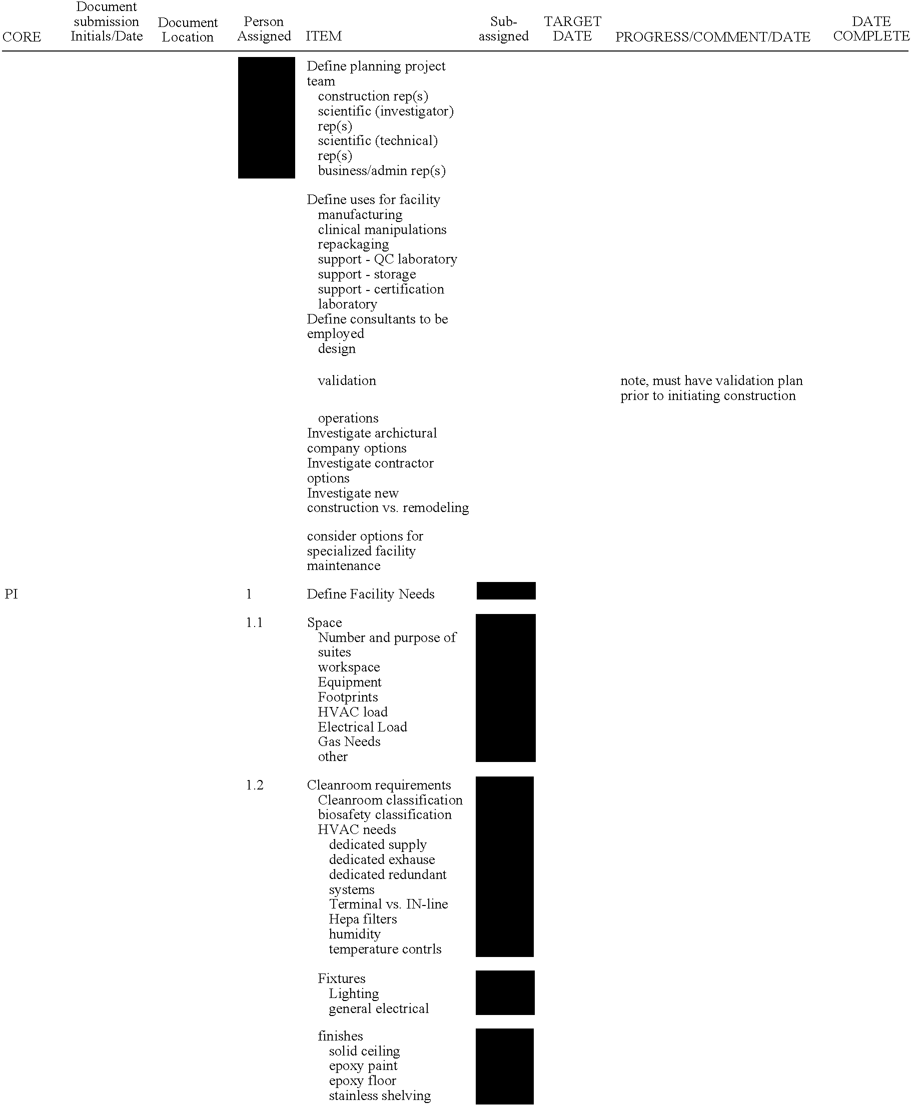

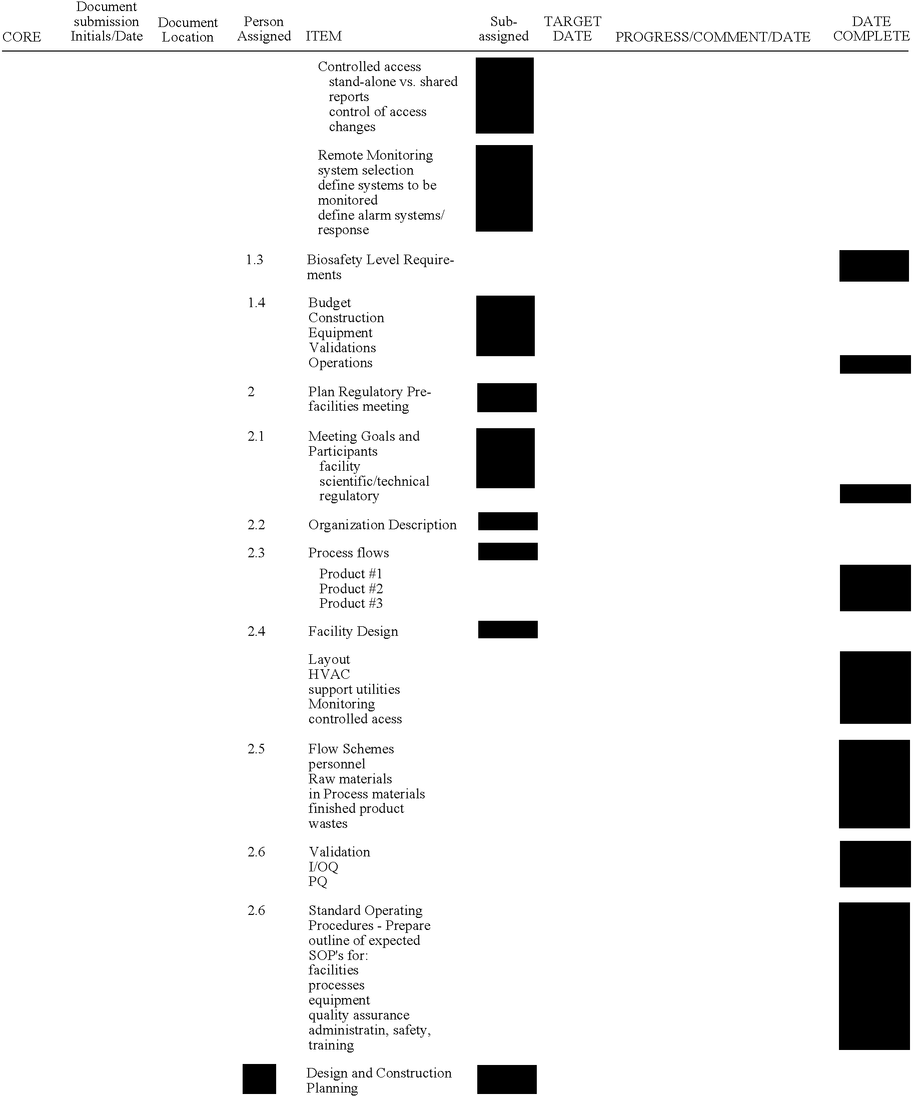

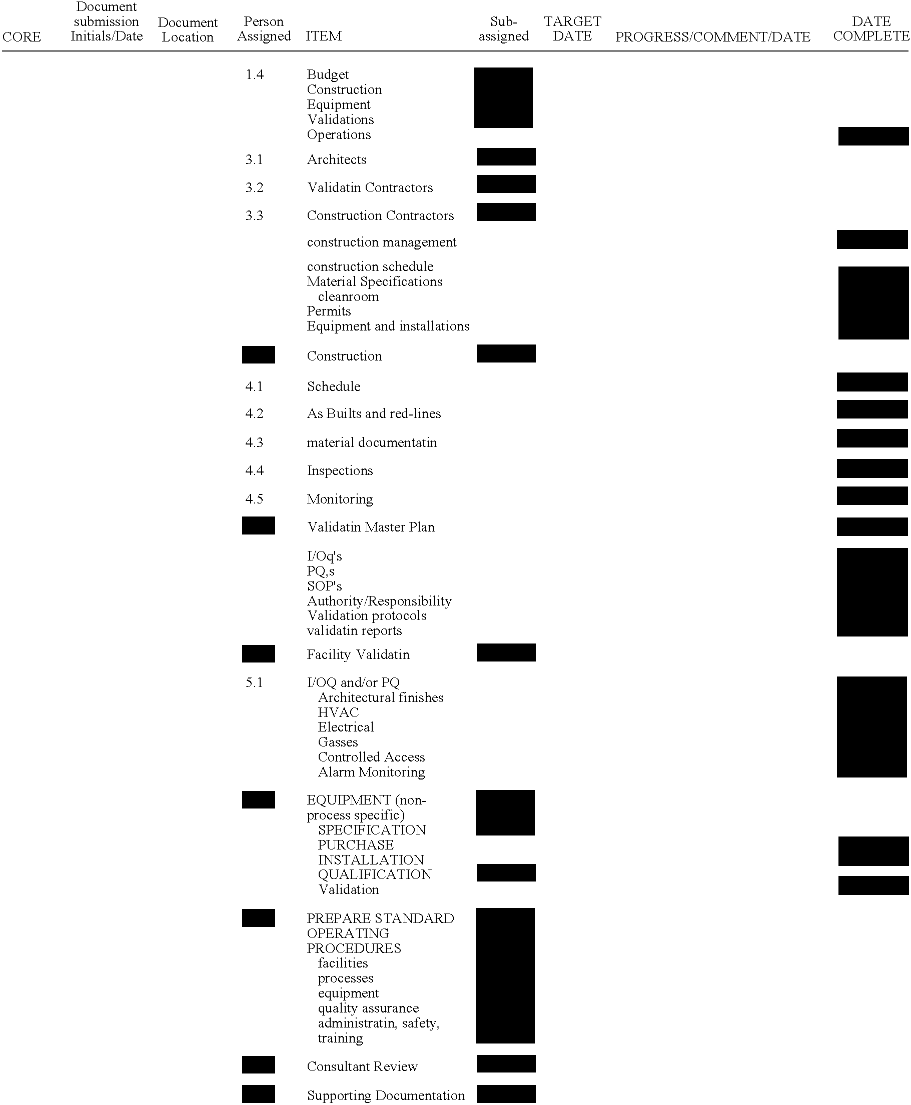

TABLE C

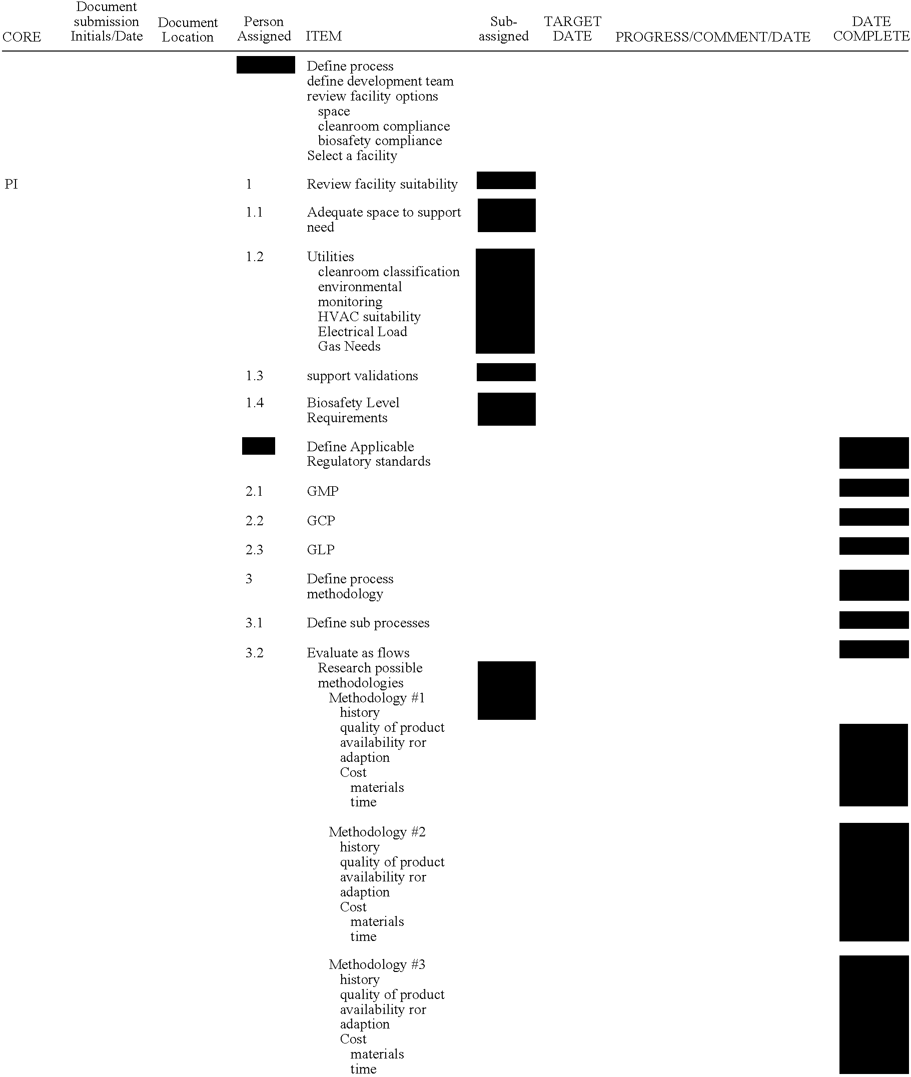

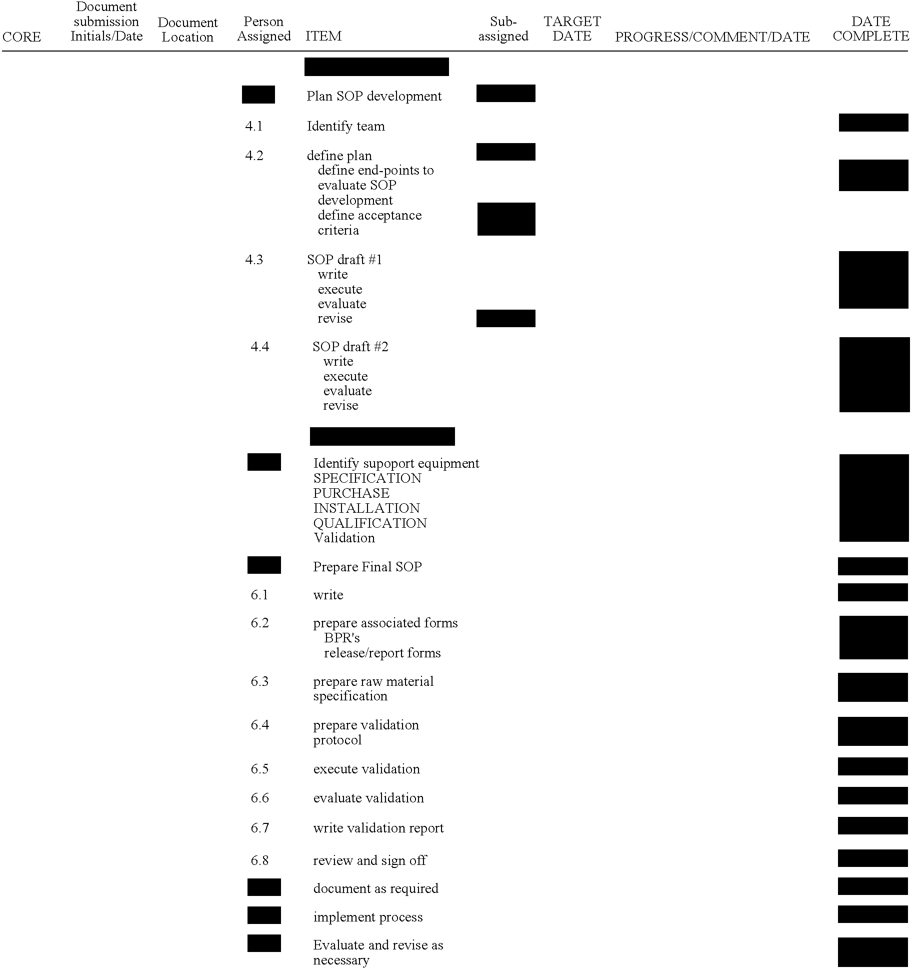

Following from the above description and the above invention summaries, it should be apparent to those of ordinary skill in the art that, while the systems and processes herein described constitute exemplary embodiments of the present invention, it is to be understood that the invention is not limited to these precise systems and processes and that changes may be made therein without departing from the scope of the invention as defined by the claims. Additionally, it is to be understood that the invention is defined by the claims and it is not intended that any limitations or elements describing the exemplary embodiments set forth herein are to be incorporated into the meaning of the claims unless such limitations or elements are explicitly listed in the claims. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A computer memory comprising a knowledge base for providing a clinical development plan of a molecular or cellular phase I or II clinical trial, the knowledge base comprising:
itemized steps for the clinical development of a product from a development laboratory to a clinical trail.

2. The computer memory of claim 1, wherein the itemized steps provide steps for performing one or more of the following tasks:
a task of establishing preclinical research, demonstrating proof of principle data and history of project development;
a task of developing protocol and associated regulatory submissions and documents;
a task of establishing facility and equipment requirements;
a task of establishing manufacturing process requirements, including methods and raw material specifications for active and ancillary products;
a task of establishing data and specimen management documents and procedures; and
a task of establishing post trail monitoring methods.

3. The computer memory of claim 2, wherein each task comprises one or more subtasks.

4. The computer memory of claim 3, wherein the itemized steps provide steps for performing all of the following tasks:
a task of establishing preclinical research, demonstrating proof of principle data and history of project development;
a task of developing protocol and associated regulatory submissions and documents;
a task of establishing facility and equipment requirements;
a task of establishing manufacturing process requirements, including methods and raw material specifications for active and ancillary products;
a task of establishing data and specimen management documents and procedures; and
a task of establishing post trail monitoring methods.

5. The computer memory of claim 4, wherein the knowledge base comprises a spread sheet, wherein the tasks are itemized within the spreadsheet.

6. The computer memory of claim 5, wherein the spreadsheet further includes links to external documents associated with one or more of the tasks.

7. The computer memory of claim 6, wherein the spreadsheet includes, for each task, a target date field, a notes field and a date complete field.

8. The computer memory of claim 7, wherein the spreadsheet further includes for each task, a personnel assignment field.

9. The computer memory of claim 1, wherein the knowledge base comprises a spread sheet, wherein the tasks are itemized within the spreadsheet.

10. The computer memory of claim 9, wherein the spreadsheet further includes links to external documents associated with one or more of the tasks.

11. The computer memory of claim 10, wherein the spreadsheet includes, for each task, a target date field, a notes field and a date complete field.

12. The computer memory of claim 11, wherein the spreadsheet further includes for each task, a personnel assignment field.

13. The computer memory of claim 10, wherein the documents are categorized by project, area of work, and task.

14. The computer memory of claim 9, wherein the spreadsheet includes means for indicating whether a specific task is complete.

15. The computer memory of claim 9, wherein the spreadsheet is customizable by at least an administrator to meet specific requirements of a given project.

16. The computer memory of claim 1, wherein the knowledge base is customizable by at least an administrator to meet specific requirements of a given project.

17. The computer memory of claim 1, further comprising documents and/or files associated with one or more of the itemized steps; wherein the one or more itemized steps include links to the respective documents and/or files.

18. A computer memory comprising a knowledge base for providing a clinical facility development plan, the knowledge base comprising:
itemized steps for a clinical facility design, construction and validation.

19. The computer memory of claim 18, wherein the itemized steps provide steps for performing one or more of the following tasks:
a task of defining facility needs;
a task of developing clean room requirements;
a task of planning a regulatory pre-facilities meeting;
a task of planning design and construction;
a task of monitoring construction;
a task of validating master plan and facility;
a task of specifying, obtaining, and validating equipment; and
a task of preparing standard operating procedures.

20. The computer memory of claim 19, wherein each task comprises one or more subtasks.

21. The computer memory of claim 20, wherein the itemized steps provide steps for performing all of the following tasks:
a task of defining facility needs;
a task of developing clean room requirements;
a task of planning a regulatory pre-facilities meeting;
a task of planning design and construction;
a task of monitoring construction;
a task of validating master plan and facility;
a task of specifying, obtaining, and validating equipment; and
a task of preparing standard operating procedures.

22. The computer memory of claim 21, wherein the knowledge base comprises a spread sheet, wherein the tasks are itemized within the spreadsheet.

23. The computer memory of claim 22, wherein the spreadsheet further includes links to external documents associated with one or more of the tasks.

24. The computer memory of claim 23, wherein the spreadsheet includes, for each task, a target date field, a notes field and a date complete field.

25. The computer memory of claim 24, wherein the spreadsheet further includes for each task, a personnel assignment field.

26. The computer memory of claim 18, wherein the knowledge base comprises a spread sheet, wherein the tasks are itemized within the spreadsheet.

27. The computer memory of claim 26, wherein the spreadsheet further includes links to external documents associated with one or more of the tasks.

28. The computer memory of claim 27, wherein the spreadsheet includes, for each task, a target date field, a notes field and a date complete field.

29. The computer memory of claim 28, wherein the spreadsheet further includes for each task, a personnel assignment field.

30. The computer memory of claim 27, wherein the documents are categorized by project and task.

31. The computer memory of claim 26, wherein the spreadsheet includes means for indicating whether a specific task is complete.

32. The computer memory of claim 26, wherein the spreadsheet is customizable by at least an administrator to meet specific requirements of a given project.

33. The computer memory of claim 18, wherein the knowledge base is customizable by at least an administrator to meet specific requirements of a given project.

34. The computer memory of claim 18, further comprising documents and/or files associated with one or more of the itemized steps; wherein the one or more itemized steps include links to the respective documents and/or files.

35. A computer memory comprising a knowledge base for providing a process development plan for developing and validating a manufacturing or analytic process and/or a clinical trial in an academic or research institution:
itemized steps for the development and validation of a manufacturing or analytic process and/or a clinical trial in an academic or research institution.

36. The computer memory of claim 35, wherein the itemized steps provide steps for performing one or more of the following tasks:
a task of defining a process;
a task of reviewing facility suitability;
a task of defining applicable regulatory standards;
a task of defining process methodology;
a task of planning SOP development;
a task of specifying and acquiring support equipment;
a task of preparing final SOP; and
a task of implementing the process.

37. The computer memory of claim 36, wherein each task comprises one or more subtasks.

38. The computer memory of claim 36, wherein the itemized steps provide steps for performing all of the following tasks:
a task of defining a process;
a task of reviewing facility suitability;
a task of defining applicable regulatory standards;
a task of defining process methodology;
a task of planning SOP development;
a task of specifying and acquiring support equipment;
a task of preparing final SOP; and
a task of implementing the process.

39. The computer memory of claim 38, wherein the knowledge base comprises a spread sheet, wherein the tasks are itemized within the spreadsheet.

40. The computer memory of claim 39, wherein the spreadsheet further includes links to external documents associated with one or more of the tasks.

41. The computer memory of claim 40, wherein the spreadsheet includes, for each task, a target date field, a notes field and a date complete field.

42. The computer memory of claim 41, wherein the spreadsheet further includes for each task, a personnel assignment field.

43. The computer memory of claim 35, wherein the knowledge base comprises a spread sheet, wherein the tasks are itemized within the spreadsheet.

44. The computer memory of claim 43, wherein the spreadsheet further includes links to external documents associated with one or more of the tasks.

45. The computer memory of claim 44, wherein the spreadsheet includes, for each task, a target date field, a notes field and a date complete field.

46. The computer memory of claim 45, wherein the spreadsheet further includes for each task, a personnel assignment field.

47. The computer memory of claim 44, wherein the documents are categorized by project, area of work, and task.

48. The computer memory of claim 43, wherein the spreadsheet includes means for indicating whether a specific task is complete.

49. The computer memory of claim 43, wherein the spreadsheet is customizable by at least an administrator to meet specific requirements of a given project.

50. The computer memory of claim 35, wherein the knowledge base is customizable by at least an administrator to meet specific requirements of a given project.

51. The computer memory of claim 35, further comprising documents and/or files associated with one or more of the itemized steps; wherein the one or more itemized steps include links to the respective documents and/or files.
